(19) United States
(12) Patent Application Publication
(10) Pub. No.: US 2014/0251171 A1
(43) Pub. Date: Sep. 11, 2014

(54) DEVICE FOR POSITIONING PLATEN ROLLER

(71) Applicant: TSC AUTO ID TECHNOLOGY CO., LTD., Taipei City (TW)

(72) Inventor: MING-CHUN HO, NEW TAIPEI CITY (TW)

(73) Assignee: TSC AUTO ID TECHNOLOGY CO., LTD., TAIPEI CITY (TW)

(21) Appl. No.: 13/785,321

(22) Filed: Mar. 5, 2013

(51) Int. Cl. B41J 11/04

(52) U.S. Cl. CPC B41J 11/04
USPC 101/407.1

(57) ABSTRACT

A device for positioning a platen roller is provided, the device including a body, a first clip, a second clip, a first rotating arm, a second rotating arm, a first linkage, a second linkage and a first elastic element. The first clip and the second clip are disposed movably on the body; the first and the second rotating arm are disposed rotatably on the body; the first linkage couples the first rotating arm and the first clip; the second linkage couples the second rotating arm and the second clip; the first elastic element connects the first clip and the second clip, wherein when the first clip and the second clip move toward a first moving direction and a second moving direction respectively, the first elastic element provides elasticity so that the first clip and the second clip restore.

### BACKGROUND OF THE INVENTION

1. Field of the Invention

The present invention relates to a device for positioning a platen roller and more particularly, relates to a device positioning a platen roller via an elasticity generated by an elastic element.

2. Description

Printers are everywhere in our daily life, especially printers printing tags, barcodes, or thermal printers printing receipts. Platen rollers are widely used in these printers for providing papers, carbon sheets or ink ribbons. A platen roller is usually placed inside a positioning room with two ends or assembled and fixed on clips directly.

Although positioning a platen roller in a positioning room is very convenient, when the weight of carriers on the platen roller decreases, the platen roller tends to be moved since it is positioned by its weight; on the other hand, although positioning a platen roller by assembling is stable, the operation is more difficult and inconvenient.

Thus, a device for positioning a platen roller is provided for positioning the platen roller more efficiently and conveniently.

### SUMMARY OF THE INVENTION

In prior art, positioning a platen roller in a positioning room is very convenient, but when the weight of carriers on the platen roller decreases, the platen roller tends to be moved since it is positioned by its weight; also, although positioning a platen roller by assembling is stable, the operation is more difficult and inconvenient. Therefore, a device for positioning a platen roller is provided for positioning the platen roller more efficiently and conveniently.

A device for positioning a platen roller is provided according to embodiments of the present invention, the device including a body, a first clip, a second clip, a first rotating arm, a second rotating arm, a first linkage, a second linkage and a first elastic element. The first clip is disposed movably toward a first moving direction back and forth on the body; the second clip is disposed movably toward a second moving direction back and forth on the body, the second moving direction is opposite to the first moving direction; the first rotating arm is disposed rotatably on the body; the second rotating arm is disposed rotatably on the body; the first linkage couples the first rotating arm and the first clip; the second linkage couples the second rotating arm and the second clip; the first elastic element connects the first clip and the second clip. When the first clip moves toward the first moving direction, the first elastic element provides elasticity so that the first clip restores toward the second moving direction; when the second clip moves toward the second moving direction, the first elastic element provides elasticity so that the second clip restores toward the first moving direction.

According to an embodiment of the present invention, the first clip includes a first holder and the second clip includes a second holder; two ends of the first elastic element are respectively hooked with the first holder and the second holder. Preferably, the device further includes a second elastic element; two ends of the second elastic element are respectively hooked with the first holder and the second holder.

According to an embodiment of the present invention, the device further includes a second elastic element connecting the first clip and the second clip so the first clip and the second clip restore.

According to an embodiment of the present invention, the first rotating arm includes a first gear and the second rotating arm includes a second gear; the first gear meshes with the second gear so the first rotating arm and the second rotating arm rotate simultaneously.

According to an embodiment of the present invention, the first linkage includes a crank.

According to an embodiment of the present invention, the second linkage includes a crank.

According to an embodiment of the present invention, the first clip includes a coupling unit, a clip body and a positioning element, the coupling unit attached to the first linkage, the clip body attached to the coupling unit, the positioning element disposed rotatably to the clip body. Preferably, the clip body includes a positioning bump.

According to an embodiment of the present invention, the second clip includes a coupling unit, a clip body and a positioning element, the coupling unit attached to the second linkage, the clip body attached to the coupling unit, the positioning element disposed rotatably to the clip body. Preferably, the clip body includes a positioning bump.

According to an embodiment of the present invention, the body includes a plurality of positioning grooves; the first clip and the second clip are positioned in the positioning grooves detachably.

Therefore, when a user moves the first clip and the second clip toward the first moving direction and the second moving direction respectively with the first elastic element, the elasticity generated when stretching the first elastic element helps the first clip and the second clip to restore and position the platen roller.

Besides, the first gear of the first rotating arm meshes the second gear of the second rotating arm so that the first clip and the second clip move simultaneously, which provides efficiency and convenience.

### BRIEF DESCRIPTION OF THE DRAWINGS

Other features and advantages of this invention will become more apparent in the following detailed description of the preferred embodiments of this invention, with reference to the accompanying drawings.

FIG. 1 is a schematic view showing the front of a device for positioning a platen roller according to an embodiment of the present invention.

FIG. 2 is a schematic view showing the back of a device for positioning a platen roller according to an embodiment of the present invention.

FIG. 3 is a three-dimensional view of a first clip according to an embodiment of the present invention.

FIG. 4 is a three-dimensional view showing another side of the first clip according to an embodiment of the present invention.

FIG. 5 is a schematic view showing the back of a device for positioning a platen roller according to an embodiment of the present invention, wherein a first clip moves toward a first moving direction and a second clip moves toward a second moving direction so that a first elastic element and a second elastic element are stretched.

FIG. 6 is a schematic view showing the front of a device for positioning a platen roller according to an embodiment of the present invention, wherein a first clip and a second clip position the platen roller with the elasticity generated by a first elastic element and a second elastic element.

### DETAILED DESCRIPTION OF THE PREFERRED EMBODIMENT

The present invention relates to a device for positioning a platen roller. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

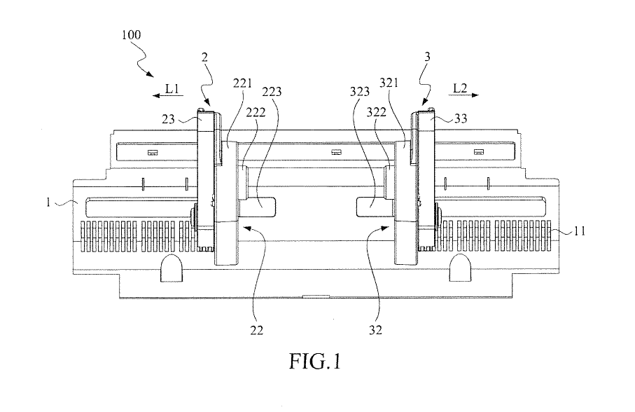

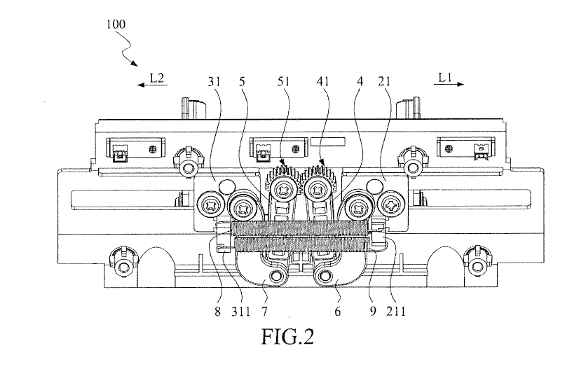

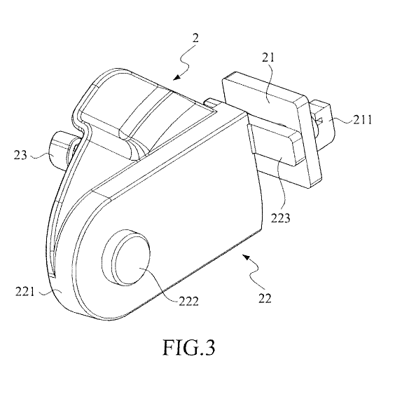

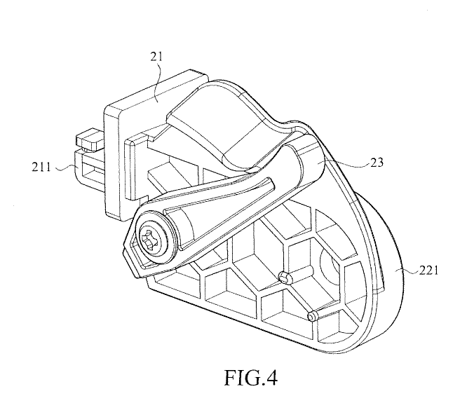

Refer to FIGS. 1, 2, 3 and 4; FIG. 1 is a schematic view showing the front of a device for positioning a platen roller according to an embodiment of the present invention; FIG. 2 is a schematic view showing the back of the device for positioning a platen roller according to the embodiment of the present invention; FIG. 3 is a three-dimensional view of a first clip according to the embodiment of the present invention; FIG. 4 is a three-dimensional view showing another side of the first clip according to the embodiment of the present invention. A device 100 for positioning a platen roller is provided according to the embodiment of the present invention, the device 100 including a body 1, a first clip 2, a second clip 3, a first rotating arm 4, a second rotating arm 5, a first linkage 6, a second linkage 7, a first elastic element 8 and a second elastic element 9.

The body 1 includes a plurality of positioning grooves 11. The first clip 2 is disposed movably toward a first moving direction L1 back and forth on the body 1 and includes a coupling unit 21, a clip body 22 and a positioning element 23. The coupling unit 21 includes a first holder 211. The clip body 22 includes a clip body unit 221, a positioning bump 222 and a coupling part 223. The positioning bump 222 protrudes outward from the clip body unit 221 integrally; the coupling part 223 integrally connects the clip body unit 221 and attaches the coupling unit 21. The positioning element 23 is disposed rotatably to the clip body unit 221.

The second clip 3 is disposed movably toward a second moving direction L2 back and forth on the body 1, the second moving direction L2 is opposite to the first moving direction Ll. The second clip 3 includes a coupling unit 31, a clip body 32 and a positioning element 33. The coupling unit 31 includes a second holder 311. The clip body 32 includes a clip body unit 321, a positioning bump 322 and a coupling part 323. The positioning bump 322 protrudes outward from the clip body unit 321 integrally; the coupling part 323 integrally connects the clip body unit 321 and attaches the coupling unit 31. The positioning element 33 is disposed rotatably to the clip body unit 321. According to the embodiment of the present invention, grooves (not shown) are included in the body 1 for the first clip 2 and the second clip 3 to move back and forth and limitedly toward the first moving direction L1 and the second moving direction L2.

The first rotating arm 4 includes a first gear 41 disposed rotatably on the body 1.

The second rotating arm 5 includes a second gear 51 disposed rotatably on the body 1, wherein the first gear 41 meshes with the second gear 51 so the first rotating arm 4 and the second rotating arm 5 rotate simultaneously.

The first linkage 6 couples the first rotating arm 4 and attaches the coupling unit 21 of the first clip 2. The second linkage 7 couples the second rotating arm 5 and attaches the coupling unit 31 of the second clip 3. The first linkage 6 and the second linkage 7 include a crank.

Two ends of the first elastic element 8 are respectively hooked with the first holder 211 of the first clip 2 and the second holder 311 of the second clip 3; also, two ends of the second elastic element 9 are respectively hooked with the first holder 211 of the first clip 2 and the second holder 311 of the second clip 3. According to the embodiment of the present invention, the first elastic element 8 and the second elastic element 9 include a spring and respectively hook with the first holder 211 and the second holder 311. Thus, when the first clip 2 moves toward the first moving direction L1 and when the second clip 3 moves toward the second moving direction L2, the first elastic element 8 and the second elastic element 9 provide elasticity so that the first clip 2 restores toward the second moving direction L2 and the second clip 3 restores toward the first moving direction L1.

Besides, since the first linkage 6 couples the first clip 2 and the first rotating aim 4 and the second linkage 7 couples the second clip 3 and the second rotating arm 5, and since the first rotating arm 4 and the second rotating arm 5 mesh with each other via the meshing first gear 41 and second gear 51, when the first clip 2 moves toward the moving direction L1, the second clip 3 is simultaneously driven and moves toward the moving direction L2.

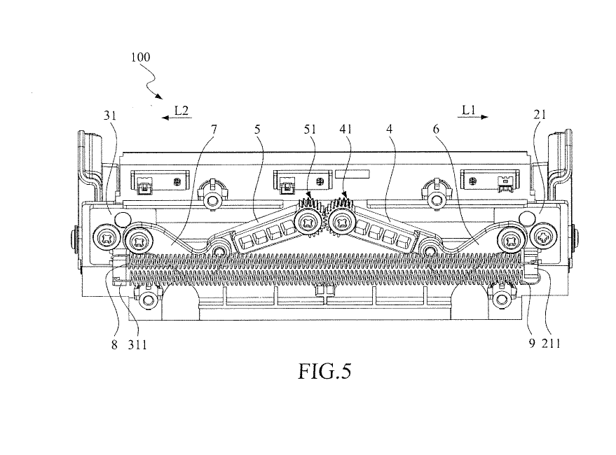

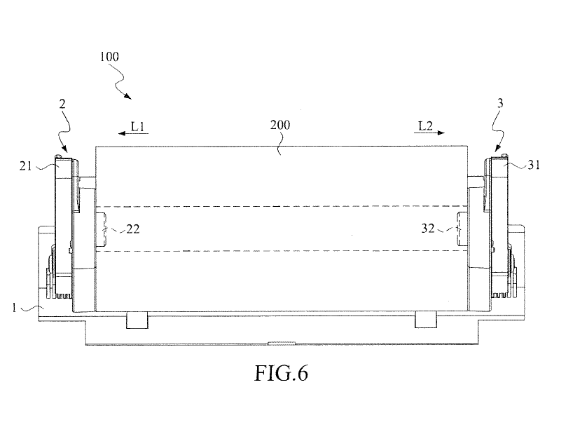

Refer to FIG. 5 and FIG. 6; FIG. 5 is a schematic view showing the back of the device for positioning a platen roller according to the embodiment of the present invention, wherein the first clip moves toward the first moving direction and the second clip moves toward the second moving direction so that the first elastic element and the second elastic element are stretched; FIG. 6 is a schematic view showing the front of the device for positioning a platen roller according to the embodiment of the present invention, wherein the first clip and the second clip position the platen roller with the elasticity generated by the first elastic element and the second elastic element.

According to FIG. 5 and FIG. 6, a user moves the first clip 2 and the second clip 3 toward the first moving direction L1 and the second moving direction L2, places a platen roller 200 between the first clip 2 and the second clip 3, by the elasticity generated from the stretch of the first elastic element 8 and the second elastic element 9, the first clip 2 and the second clip 3 restore respectively toward the second moving direction L2 and the first moving direction L1, and positions the platen roller 200 with the clip body 22 and 32. Since the positioning element 23 and 33 are disposed rotatably and respectively on the clip body 22 and 32, by slotting the positioning element 23 and 33 into the grooves 11, the first clip 2 and the second clip 3 are positioned on the body 1. According to other embodiments of the present invention, the first clip 2 and the second clip 3 are positioned with about the length of the platen roller 200 and the platen roller 200 is positioned by the positioning bump 222 and 322 so there is space for the platen roller 200.

In other embodiments of the present invention, a positioning unit can be fixed on the body and the platen roller is installed on the positioning unit so the platen roller and the positioning unit rotate correspondingly.

Persons having ordinary skill in the art should be able to know that compared with prior art, in which since a platen roller is positioned in a position room, the platen roller is not able to be positioned efficiently once the weight of the platen roller decreases and positioning a platen roller by assembly is complicate and inconvenient, the device for positioning a platen roller according to the present invention is more efficient—the first elastic element and the second elastic element provide elasticity for the first clip and the second clip to restore and for positioning the platen roller. In other embodiments of the present invention, the second elastic element may not be necessary since the second elastic element provides more elasticity and more even force.

In conclusion, the user merely needs to move one of the first clip and the second clip to position a platen roller between the first clip and the second clip and to position the platen roller with the elasticity provided by the first elastic element. Therefore, the device for positioning a platen roller according to embodiments of the present invention is very convenient and stable to operate.

Besides, coupling the first clip and the second clip with the first linkage, the first rotating arm, the second rotating arm and the second linkage provides efficiency and convenience since the second clip moves toward the second moving direction simultaneously when the first clip moves toward the first moving direction.

While the present invention has been particularly shown and described with reference to a preferred embodiment, it will be understood by those skilled in the art that various changes in form and detail may be without departing from the spirit and scope of the present invention.

What is claimed is:

1. A device for positioning a platen roller, the device comprising:
a body;
a first clip disposed movably toward a first moving direction back and forth on the body;
a second clip disposed movably toward a second moving direction back and forth on the body, the second moving direction is opposite to the first moving direction;
a first rotating arm disposed rotatably on the body;
a second rotating arm disposed rotatably on the body;
a first linkage coupling the first rotating arm and the first clip;
a second linkage coupling the second rotating arm and the second clip; and
a first elastic element connecting the first clip and the second clip;
wherein when the first clip moves toward the first moving direction, the first elastic element provides elasticity so that the first clip restores toward the second moving direction; when the second clip moves toward the second moving direction, the first elastic element provides elasticity so that the second clip restores toward the first moving direction.

2. The device according to claim 1, wherein the first clip includes a first holder and the second clip includes a second holder; two ends of the first elastic element are respectively hooked with the first holder and the second holder.

3. The device according to claim 2, further including a second elastic element; two ends of the second elastic element are respectively hooked with the first holder and the second holder.

4. The device according to claim 1, wherein the first rotating arm includes a first gear and the second rotating arm includes a second gear; the first gear meshes with the second gear so the first rotating arm and the second rotating arm rotate simultaneously.

5. The device according to claim 1, wherein the first linkage includes a crank.

6. The device according to claim 1, wherein the second linkage includes a crank.

7. The device according to claim 1, wherein the first clip includes a coupling unit, a clip body and a positioning element, the coupling unit attached to the first linkage, the clip body attached to the coupling unit, the positioning element disposed rotatably to the clip body.

8. The device according to claim 7, wherein the clip body includes a positioning bump.

9. The device according to claim 1, wherein the second clip includes a coupling unit, a clip body and a positioning element, the coupling unit attached to the second linkage, the clip body attached to the coupling unit, the positioning element disposed rotatably to the clip body.

10. The device according to claim 9, wherein the clip body includes a positioning bump.

11. The device according to claim 1, wherein the body includes a plurality of positioning grooves; the first clip and the second clip are positioned in the positioning grooves detachably.
